(19) United States
(12) Patent Application Publication
(10) Pub. No.: US 2020/0065638 A1
(43) Pub. Date: Feb. 27, 2020

(54) IMAGE FORMING APPARATUS AND IMAGE FORMING APPARATUS SYSTEM

(71) Applicant: SHARP KABUSHIKI KAISHA, Sakai City (JP)

(72) Inventors: YASUHIRO NAKAI, Sakai City (JP); KOHJI KATAMOTO, Sakai City (JP); KOHICHI MURAKAMI, Sakai City (JP); YASUTOMO HAYANO, Sakai City (JP); MASAO SAEDA, Sakai City (JP)

(21) Appl. No.: 16/541,661

(22) Filed: Aug. 15, 2019

(30) Foreign Application Priority Data
Aug. 23, 2018 (JP) 2018-156289

(51) Int. Cl. G06K 19/06; G06K 7/14; H04N 1/00; H04N 1/32

(52) U.S. Cl. CPC G06K 19/06037; G06K 7/1417; H04N 2201/3269; H04N 1/00962; H04N 1/32144; H04N 1/00307

(57) ABSTRACT

An image forming apparatus includes: a QR code reader that reads a QR code; a code analyzer that analyzes the QR code read by the QR code reader and that generates use history information that is information regarding history of use information of a user; an information updater that adds use information obtained this time to the use history information generated by the code analyzer to update the use history information; a code generator that generates a QR code based on the use history information updated by the information updater; and a display unit that outputs the QR code generated by the code generator.

### BACKGROUND

### 1. Field

The present disclosure relates to an image forming apparatus and an image forming apparatus system in which operations are supported with image codes.

### 2. Description of the Related Art

Image forming apparatuses, such as copiers, facsimile apparatuses, printers, and multifunctional equipment, may be placed at convenience stores. When such an image forming apparatus is placed at a convenience store or the like, a large number of unspecified users use the image forming apparatus and thus include users who do not know how to operate the image forming apparatus and users who are not accustomed to the operation. Accordingly, there are demands for image forming apparatuses that can be easily operated, and, for example, an image forming apparatus that is a dialogue type and on which users sequentially perform operation settings in accordance with instructions displayed on a screen has been available. With such a dialogue-type image forming apparatus, however, since users have to sequentially perform settings in accordance with instructions, there is a problem that it is even more troublesome for users who are accustomed to the operation.

Some image forming apparatuses placed at convenience stores and so on have not only a copy service and a facsimile service but also a function called a content service. The “content service” as used herein refers to a service function that enables printing photographs, photographic portraits of celebrities, musical scores, newspapers, maps, and other information. For using the content service, there are cases in which each user selects content he or she desires by using the screen or the like of the image forming apparatus, and for example, there are also cases in which each user pre-checks a number or the like regarding desired content with a content-service-providing website or the like and inputs the number by using a personal computer at home or the like. In such cases, the user has to make a note of the number checked using the personal computer, bring the memo to the convenience store, and then operate the image forming apparatus to enter the number, and such a task is cumbersome, which is a problem.

In such image forming apparatuses, there are demands for image forming apparatuses that are easier to operate, and various image forming apparatuses have been proposed. For example, Japanese Unexamined Patent Application Publication No. 2007-36404 (hereinafter referred to as “Patent Document 1”) discloses an image forming apparatus that displays image data based on operation settings set when a user performed an operation. According to this image forming apparatus, a user uses a portable terminal to photograph and store the image data displayed after operating the image forming apparatus, and next time the user uses the image forming apparatus, the user makes the image forming apparatus read the image data stored in the portable terminal, so that operation settings that are the same as those in the last operation are performed. This allows the user to easily perform operation settings.

As described above, the image forming apparatus described in Patent Document 1 can reduce the amount of burden on users. However, there are demands for an image forming apparatus that can further reduce the amount of burden on users. For example, each user may use operation settings that differ from the last operation settings, and thus, with the image forming apparatus disclosed in Patent Document 1, each user has to manually re-enter operation settings for operation settings that differ from last operation settings, which is troublesome. Since content that each user desires to obtain may also be different from content that the user obtained last time, he or she has to manually enter another number corresponding to the content, which is troublesome.

The present disclosure has been made in view of the foregoing situation, and it is desirable to provide an image forming apparatus and an image forming apparatus system that reduce the amount of users' operation work.

### SUMMARY

According to an aspect of the disclosure, there is provided an image forming apparatus including: an image-code reading unit that reads an image code; a use-history-information generating unit that analyzes the image code read by the image-code reading unit and that generates use history information that is information regarding history of use information of a user; a use-history updating unit that adds use information obtained this time to the use history information generated by the use-history-information generating unit, to update the use history information; an image-code generating unit that generates the image code, based on the use history information updated by the use-history updating unit; and an image-code outputting unit that outputs the image code generated by the image-code generating unit.

According to another aspect of the disclosure, there is provided an image forming apparatus system including the image forming apparatus and a server that is transmittable/receivable data to/from the image forming apparatus. The server stores content information therein, and transmits the content information to the image forming apparatus, based on a transmission instruction from the image forming apparatus.

### BRIEF DESCRIPTION OF THE DRAWINGS

FIG. 1 is a schematic diagram illustrating a configuration of an image forming apparatus system according to a first embodiment of the present disclosure;

FIG. 2 is a perspective view illustrating a general configuration of the external appearance of an image forming apparatus included in an image forming apparatus system according to the first embodiment of the present disclosure;

FIG. 3 is a block diagram schematically illustrating a control configuration in the image forming apparatus illustrated in FIG. 2;

FIG. 4 is a block diagram schematically illustrating a control configuration in a content server included in the image forming apparatus system according to the first embodiment of the present disclosure;

FIG. 5 is a first image view illustrating one example of an image displayed on a display unit in the image forming apparatus according to the first embodiment of the present disclosure;

FIG. 6 is a second image view illustrating one example of an image displayed on the display unit in the image forming apparatus according to the first embodiment of the present disclosure;

FIG. 7 is a third image view illustrating one example of an image displayed on the display unit in the image forming apparatus according to the first embodiment of the present disclosure;

FIG. 8 is a fourth image view illustrating one example of an image displayed on the display unit in the image forming apparatus in the first embodiment of the present disclosure;

FIG. 9 is a fifth image view illustrating one example of an image displayed on the display unit in the image forming apparatus in the first embodiment of the present disclosure;

FIG. 10 is a sixth image view illustrating one example of an image displayed on the display unit in the image forming apparatus in the first embodiment of the present disclosure;

FIG. 11 is a seventh image view illustrating one example of an image displayed on the display unit in the image forming apparatus in the first embodiment of the present disclosure;

FIG. 12 is a table illustrating an example of the use history information regarding content in the image forming apparatus system in the first embodiment of the present disclosure;

FIG. 13 is a first flowchart illustrating one example of control operation in the image forming apparatus system in the first embodiment of the present disclosure;

FIG. 14 is a second flowchart illustrating one example of the control operation in the image forming apparatus system in the first embodiment of the present disclosure;

FIG. 15 is a schematic diagram illustrating the configuration of an image forming apparatus system according to a second embodiment of the present disclosure;

FIG. 16 is a block diagram schematically illustrating control configuration in an image forming apparatus included in the image forming apparatus system according to the second embodiment of the present disclosure;

FIG. 17 is a block diagram schematically illustrating a control configuration of a smartphone included in the image forming apparatus system according to the second embodiment of the present disclosure;

FIG. 18 is an image view illustrating one example of an image displayed on a display unit in the image forming apparatus according to the second embodiment of the present disclosure; and

FIG. 19 is an image view illustrating one example of an image displayed on the display unit of the image forming apparatus according to another embodiment of the present disclosure.

### DESCRIPTION OF THE EMBODIMENTS

Embodiments of the present disclosure will be described below with reference to the accompanying drawings.

### First Embodiment

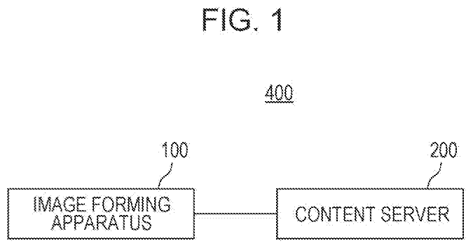

FIG. 1 is a schematic diagram illustrating a configuration of an image forming apparatus system according to a first embodiment of the present disclosure.

As illustrated in FIG. 1, an image forming apparatus system 400 includes an image forming apparatus 100 and a content server 200. The image forming apparatus 100 is placed, for example, at a convenience store.

The content server 200 is connected to the image forming apparatus 100, for example, through the Internet. The content server 200 is managed by a content provider, and specifically, the image forming apparatus 100 is used as a supply window of a content service provided by the content provider.

Examples of the content as used herein include photographs, photographic portraits of celebrities, musical scores, newspapers, maps, and other information. The image forming apparatus 100 can print such pieces of content transmitted from the content server 200. That is, a user can obtain the pieces of content by using the image forming apparatus 100.

The image forming apparatus 100 displays operation settings, set when the user used the image forming apparatus 100, as a QR code (registered trademark), which is an image code, and the user uses a portable terminal, such as a smartphone, to photograph and store the QR code. Next time the image forming apparatus 100 is used, the user makes the image forming apparatus 100 read the QR code, so that operation settings that are the same as the last operation settings are performed. In addition, the QR code includes not only the operation settings used when the image forming apparatus 100 was operated last time but also, for example, operation settings when the user used the image forming apparatus 100 earlier than the last time. That is, the QR code includes use history information of the user up to this point. The use history information is information regarding history of use information of the user.

The image forming apparatus 100 will now be described with reference to the accompanying drawings.

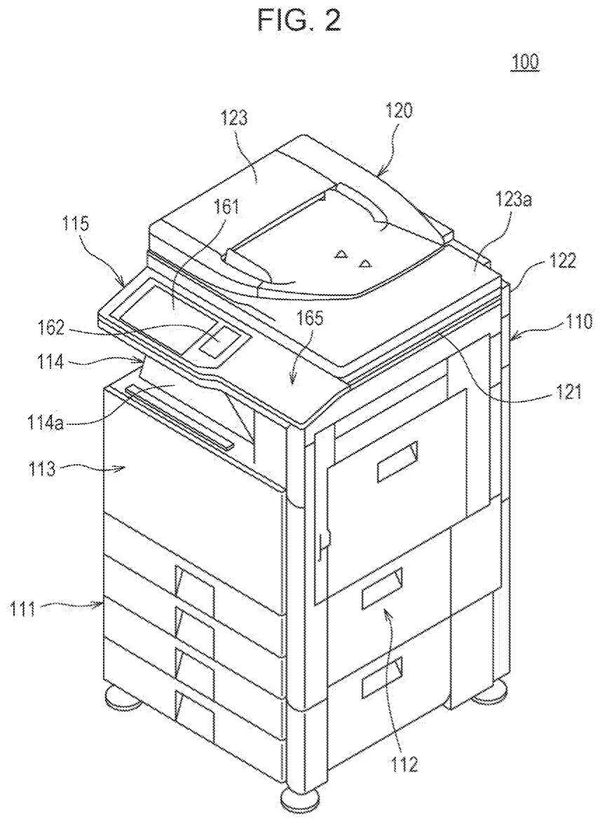

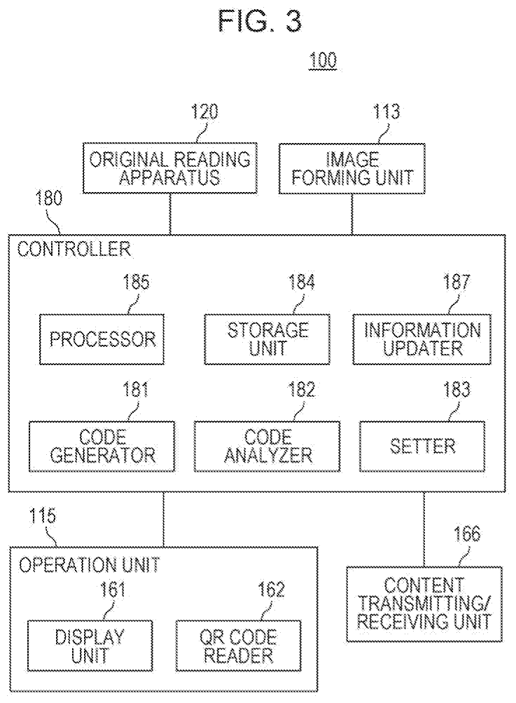

FIG. 2 is a perspective view illustrating a general configuration of the external appearance of an image forming apparatus included in an image forming apparatus system according to the first embodiment of the present disclosure. FIG. 3 is a block diagram schematically illustrating a control configuration in the image forming apparatus illustrated in FIG. 2.

As illustrated in FIG. 2, the image forming apparatus 100 includes an image-forming-apparatus main unit 110 and an original reading apparatus 120.

The original reading apparatus 120 is provided at a top portion of the image-forming-apparatus main unit 110 and includes an original placement table 121, an original reading unit 122, and an original automatic feeding device 123. In the original reading apparatus 120, the original reading unit 122 reads an image of an original placed on the original placement table 121, or the original reading unit 122 reads an image of an original automatically fed by the original automatic feeding device 123. The original reading apparatus 120 then transmits data of the read original image to the image-forming-apparatus main unit 110. The original reading apparatus 120 ejects the original conveyed by the original automatic feeding device 123 and read by the original reading unit 122 to an original ejection tray 123a.

The image-forming-apparatus main unit 110 has a sheet accommodating unit 111, a sheet conveying unit 112, an image forming unit 113, a sheet ejection unit 114, and an operation unit 115. The image-forming-apparatus main unit 110 is adapted such that record sheets, such as recording paper, are accommodated in the sheet accommodating unit 111, the sheet conveying unit 112 conveys each record sheet accommodated in the sheet accommodating unit 111, the image forming unit 113 forms a color image or a monochrome image on the record sheet conveyed by the sheet conveying unit 112 based on image data transmitted from the original reading apparatus 120 or externally, and the record sheet on which the image is formed by the image forming unit 113 is ejected to a sheet ejection tray 114a in the sheet ejection unit 114.

The operation unit 115 includes a display unit 161 and a QR code reader 162 and has an operation member 165. The display unit 161 is a touch panel display. The display unit 161 not only displays an image regarding operations but also allows a user to perform inputting by touching a screen of the display unit 161. The display unit 161 can display a QR code based on the use history information including operation settings performed by the user, which is described below. The QR code reader 162 reads a QR code. Specifically, when a QR code displayed on a display screen of a portable terminal, such as a smartphone, is placed over the QR code reader 162, the QR code reader 162 reads the QR code.

Now, a description will be given of a basic flow of a case in which a user uses the image forming apparatus 100. First, the user operates the operation unit 115 to select which task of copy, print, facsimile, scan, a content service, and so on is to be performed. For example, when the user selects the copy, he or she follows the guidance displayed on the display unit 161 to sequentially set selection of color copy or black-and-white copy, selection of the size of paper, whether enlargement or reduction is to be performed, the number of copies, and so on. Then, copy processing is performed and is completed (job completion).

When the user selects the content service, he or she selects desired content or searches for content by entering a number corresponding to the content and prints the content, thereby completing the content service processing (job completion).

As illustrated in FIG. 3, the image forming apparatus 100 further includes a controller 180 that is responsible for control of the entire image forming apparatus 100. As described above, the image forming apparatus 100 has functions of copy, print, facsimile, scan, a content service, and so on, and the controller 180 is responsible for operations for the functions and also controls operations of the original reading apparatus 120 and the image forming unit 113.

The controller 180 includes a code generator 181, a code analyzer 182, a setter 183, a storage unit 184, a processor 185, and an information updater 187.

The controller 180 includes, for example, a microcomputer, such as a central processing unit (CPU), and the storage unit 184, which is a storage device, such as a read-only memory (ROM), a random-access memory (RAM), or a data-writable nonvolatile memory.

The processor 185 is adapted to perform operation control on each constituent element by loading a control program, pre-stored in the ROM in the storage unit 184, into the RAM in the storage unit 184 and executing the control program. The PAM in the storage unit 184 provides the processor 185 with a work area for operation and a region that serves as an image memory for storing image data.

The storage unit 184 stores therein information (use information) regarding details of a service that the user uses with the image forming apparatus 100. The use information includes information about operation settings set when the user uses the image forming apparatus 100 (this information is referred to as “operation setting information”). For instance, in the content service, the use information includes, for example, a code number, the number of uses, the date and time of use, and a store code of obtained content. The operation settings refer to descriptions regarding operations set by the user. For example, in the copy processing, the operation settings include selection of color copy or black-and-white copy, selection of the size of paper, whether enlargement or reduction is to be performed, the number of copies, and so on.

The storage unit 184 also stores therein information that the user made the QR code reader 162 read before use.

When the user operates the operation unit 115 to give an instruction for converting the use history information into a QR code, the information updater 187 updates the use history information by adding use information obtained this time and stored in the storage unit 184 to use history information read by the QR code reader 162, generated by the code analyzer 182 last time the image forming apparatus 100 was used and earlier than the last time, and stored in the storage unit 184.

When use information of a predetermined of cases or more is included in the use history information, the information updater 187 deletes the oldest use information thereof and then adds the use information obtained this time to the use history information, to ensure that a number of pieces of use information, the number being larger than the predetermined number, are not included in the use history information. In the case of a QR code, 23648 characters can be stored. Accordingly, when this capacity is exceeded, new use information is not included in the QR code. Hence, it is desired that the amount of information to be included in the QR code be reduced as appropriate so that the amount of information does not exceed the capacity. As described above, when use information of a predetermined cases and more is included, the oldest use information is deleted to thereby ensure that the capacity of the QR code is not exceeded even when new use information is included.

A method other than the above-described method may be used in order to ensure that the capacity of the QR code is not exceeded. For example, when use information obtained a predetermined number or more days before is included in the use history information, the information updater 187 may add the use information obtained this time, after deleting the use information obtained the predetermined number or more days before.

The code generator 181 generates a QR code, based on the use history information including the use information obtained this time and updated by the information updater 187. The generated QR code is displayed on the display unit 161.

Generation rules for the code generator 181 to generate a QR code may be the same as generation rules for an image forming apparatus 100 placed at another store. This allows even the image forming apparatus 100 placed at the other store to use the generated QR code.

The code analyzer 182 analyzes the QR code, read by the QR code reader 162, to generate the use history information included in the QR code. The analysis of the QR code is based on the generation rules in the code generator 181. Even when a store at which the image forming apparatus 100 is placed differs, the same generation rules are used, as described above.

The setter 183 performs setting so that the use history information generated by the code analyzer 182 is stored in the storage unit 184, and the use history information stored in the storage unit 184 is used when the image forming apparatus 100 is used. Since the operation setting information is also included in the use history information, the setter 183 also performs operation settings.

The image forming apparatus 100 further includes a content transmitting/receiving unit 166. The content transmitting/receiving unit 166 transmits/receives data to/from the content server 200. Specifically, when a content request is issued in accordance with an instruction from the controller 180, the content transmitting/receiving unit 166 transmits an instruction for requesting content to the content server 200. Also, the content transmitting/receiving unit 166 receives data regarding the requested content transmitted from the content server 200.

The data regarding the content, the data being received by the content transmitting/receiving unit 166, is stored in the storage unit 184, and the image forming unit 113 prints the data on paper and outputs the paper in accordance with an instruction from the processor 185. The data regarding the content includes content data, which is data indicating details of the content, and print data, which is data to be used for printing the content.

Next, the content server 200 will be described with reference to the accompanying drawings.

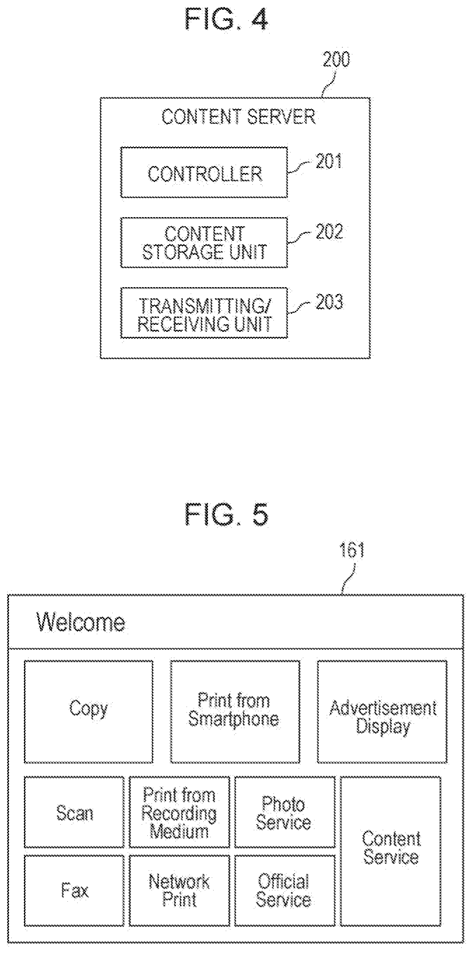

FIG. 4 is a block diagram schematically illustrating a control configuration in the content server included in the image forming apparatus system according to the first embodiment of the present disclosure.

As illustrated in FIG. 4, the content server 200 includes a controller 201, a content storage unit 202, and a transmitting/receiving unit 203.

The controller 201 centrally controls overall operation of the content server 200 and makes various determinations. The controller 201 has, for example, a microcomputer, such as a central processing unit (CPU), and storage devices, such as a read-only memory (ROM), a random-access memory (RAM), and a data-writable nonvolatile memory.

The content storage unit 202 is a storage device, such as a data-writable nonvolatile memory, and stores therein various types of content provided in the content service. These pieces of content are given content codes. Associated pieces of content are linked to each other and are stored.

The transmitting/receiving unit 203 exchanges, for example, data with the image forming apparatus 100 through the Internet.

When the transmitting/receiving unit 203 in the content server 200 receives a content transmission instruction from the image forming apparatus 100, the transmitting/receiving unit 203 notifies the controller 201 that the transmitting/receiving unit 203 has received the content transmission instruction. The controller 201 determines whether or not the present time is within a period of time in which content for which the transmission instruction was given is provided, and when the present time is within the provision period of the corresponding content, the controller 201 retrieves the content from the content storage unit 202 and causes the transmitting/receiving unit 203 to transmit the content to the image forming apparatus 100.

Also, when the present time is not within the provision period of the corresponding content, the controller 201 causes the transmitting/receiving unit 203 to issue a notification to that effect, selects and retrieves, from the content storage unit 202, similar content that is content associated with the corresponding content, and causes the transmitting/receiving unit 203 to transmit the similar content to the image forming apparatus 100. When the content corresponding to the content for which the transmission instruction was given from the image forming apparatus 100 is not stored in the content storage unit 202, the controller 201 instructs the transmitting/receiving unit 203 so as to transmit a notification to that effect to the image forming apparatus 100.

Next, a procedure in which a user uses the content service will be described with reference to what is displayed on the display unit 161 in the image forming apparatus 100.

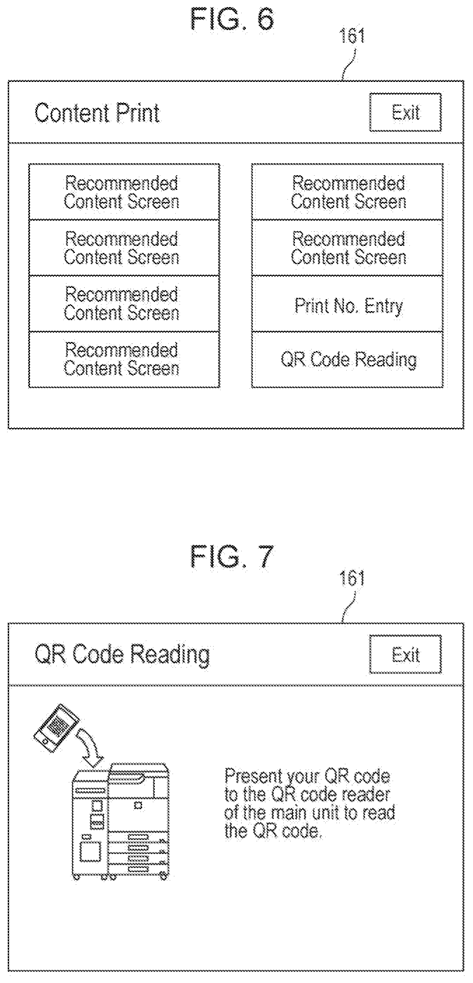

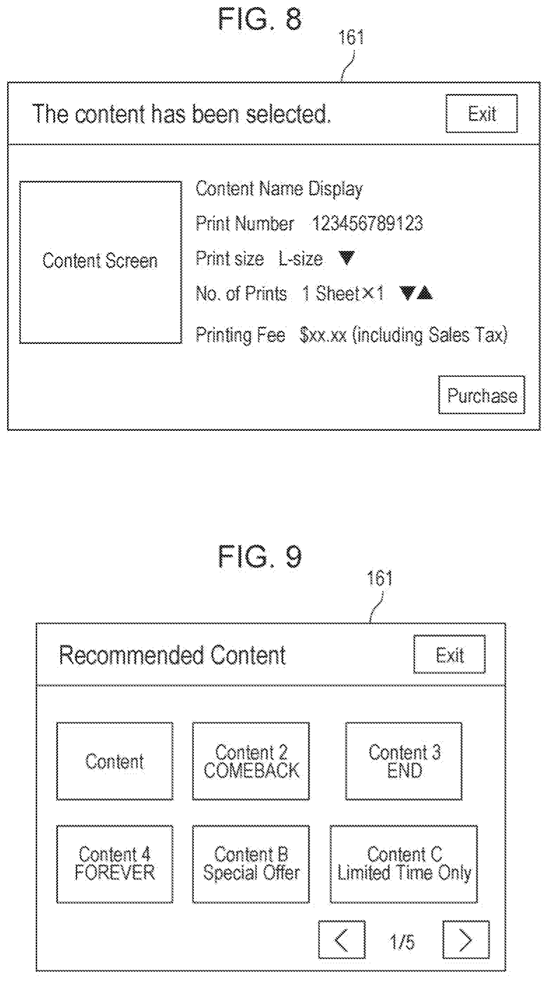

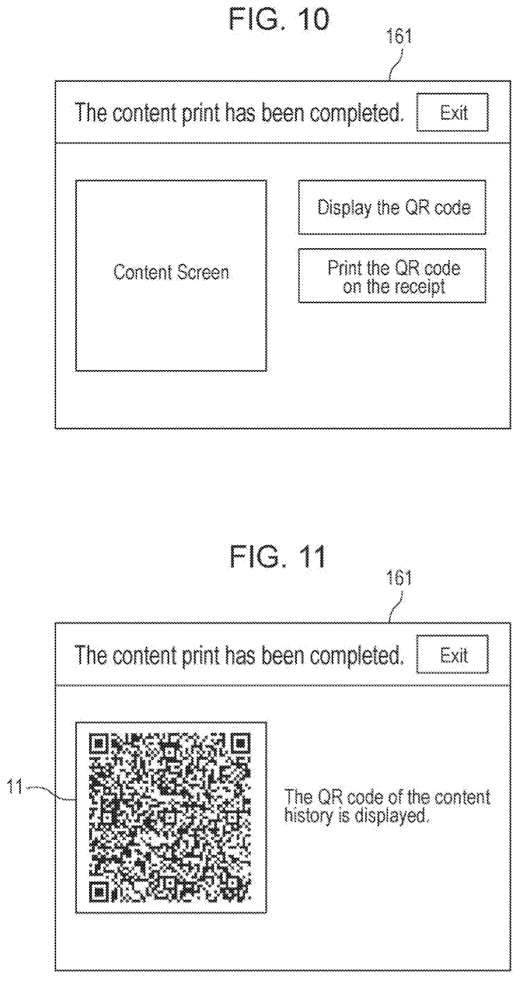

FIG. 5 is a first image view illustrating one example of an image displayed on the display unit in the image forming apparatus according to the first embodiment of the present disclosure. FIG. 6 is a second image view illustrating one example of an image displayed on the display unit in the image forming apparatus according to the first embodiment of the present disclosure. FIG. 7 is a third image view illustrating one example of an image displayed on the display unit in the image forming apparatus according to the first embodiment of the present disclosure. FIG. 8 is a fourth image view illustrating one example of an image displayed on the display unit in the image forming apparatus in the first embodiment of the present disclosure. FIG. 9 is a fifth image view illustrating one example of an image displayed on the display unit in the image forming apparatus in the first embodiment of the present disclosure. FIG. 10 is a sixth image view illustrating one example of an image displayed on the display unit in the image forming apparatus in the first embodiment of the present disclosure. FIG. 11 is a seventh image view illustrating one example of an image displayed on the display unit in the image forming apparatus in the first embodiment of the present disclosure.

As illustrated in FIG. 5, when use of the image forming apparatus 100 is started, a display for selecting various services is performed on the display unit 161. For example, when the user desires to make a copy, he or she may touch a portion where “Copy” is displayed on the display unit 161. Since the user desires to use the content service in this case, he or she touches a portion where “Content Service” is displayed on the display unit 161.

As a result, the display on the display unit 161 changes, and a screen for content selection is displayed, as illustrated in FIG. 6. For example, when the user has pre-checked a number or the like regarding content that he or she desires to use with a content-service-providing website by using a personal computer at home or the like, he or she touches a portion where “Print No. Entry” is displayed and then enters a print number to obtain the content.

Also, when the user used the content service the last time he or she used the image forming apparatus 100, and has already obtained a QR code regarding the use history information, he or she can easily select content he or she desires to use, by using the QR code. Obtaining the QR code regarding the use history information is described later. When the user uses the QR code in a manner as described above, he or she touches a portion where “QR Code Reading” is displayed.

As a result, what is displayed on the display unit 161 changes, and a screen for prompting the user to make the QR code reader 162 read the QR code is displayed, as illustrated in FIG. 7. For example, the user may cause the QR code, stored in a smartphone, to be displayed on the screen and place the smartphone over the QR code reader 162. As a result, the QR code reader 162 reads the QR code, and use history information is generated. Content or the like obtained in the past is extracted based on the use history information, and a transmission instruction is transmitted to the content server 200.

When the user operates the display unit 161 to select desired content, a screen for purchasing the content is displayed on the display unit 161, as illustrated in FIG. 8. When the user sets the number of prints of the content, the size of each print, and so on and touches a portion where “Purchase” is displayed on the screen, the image forming unit 113 prints the content on paper and ejects the paper to the sheet ejection tray 114a.

The content previously obtained by the user may include content that is not provided, for example, because of expiration of the provision period. When the user desires such content, the content server 200 transmits, to the image forming apparatus 100, pieces of similar content that are associated with the desired content. These pieces of similar content are displayed on the display unit 161. When the user desires to obtain the similar content, the user selects the similar content on the display unit 161 and touches a portion where “Purchase” is displayed on the display unit 161, as illustrated in FIG. 8.

When the content is purchased, and the print is completed (job completion), a screen indicating that the print has been completed is displayed on the display unit 161, as illustrated in FIG. 10.

When the user touches a portion where “Display the QR Code” is displayed on the screen illustrated in FIG. 10, a QR code 11 is displayed, as illustrated in FIG. 11. This QR code 11 includes use information obtained this time, in addition to use history information obtained last time the image forming apparatus 100 was used and earlier than the last time. The user may use a portable terminal, such as a smartphone, to photograph and store the QR code 11 displayed on the display unit 161. The user obtains the QR code regarding the use history information, as described above. Examples of the portable terminals include mobile phones, digital cameras, tablet computers, and notebook computers, in addition to smartphones.

When the user touches a portion where “Print the QR code on the receipt” is displayed on the screen illustrated in FIG. 10, the QR code 11 is printed on a receipt passed during payment at a convenience store. For example, although not illustrated, the image forming apparatus 100 and a cash register at the convenience store may be connected to each other through a link, data of the QR code 11 may be transmitted from the image forming apparatus 100 to the cash register, and the QR code 11 may be printed on the receipt.

Now, a description will be given of an example of the use history information regarding content.

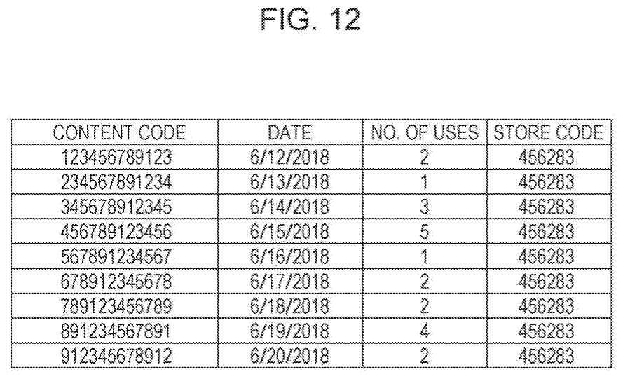

FIG. 12 is a table illustrating an example of the use history information regarding content in the image forming apparatus system in the first embodiment of the present disclosure.

As illustrated in FIG. 12, with respect to pieces of content that were used, the use history information includes content codes, which are numbers of the respective pieces of content, dates when they were used, and the numbers of uses, and store codes.

Next, one example of the operation of the image forming apparatus system 400 will be described with reference to flowcharts.

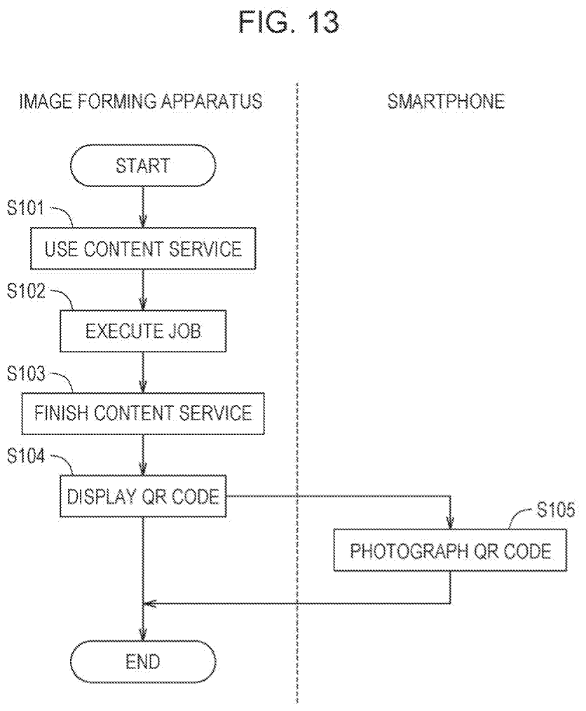

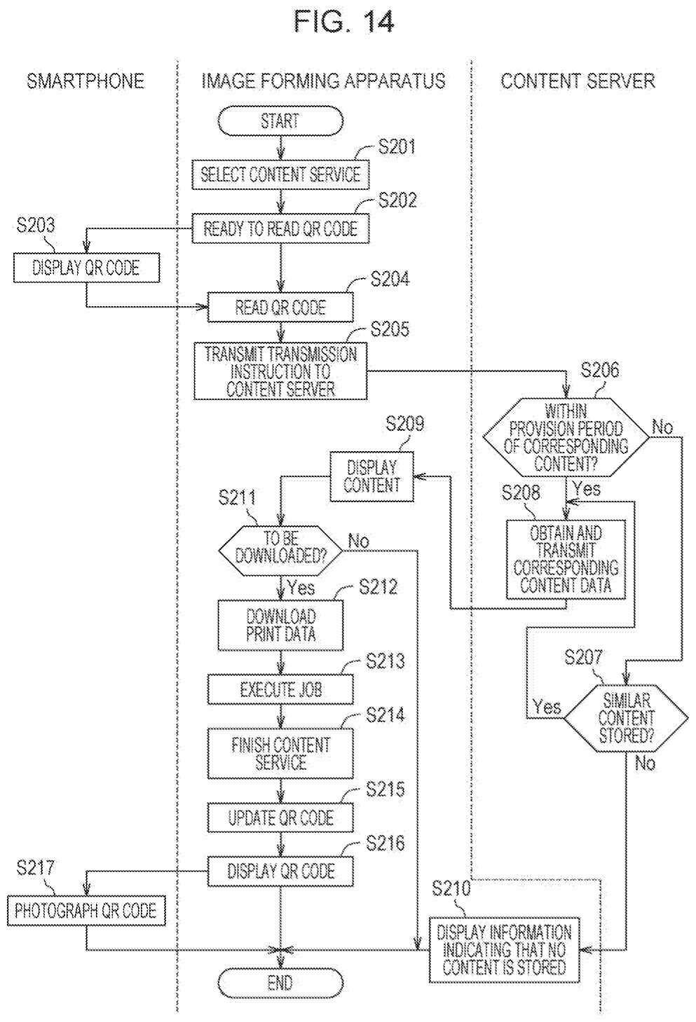

FIG. 13 is a first flowchart illustrating one example of control operation in the image forming apparatus system in the first embodiment of the present disclosure. FIG. 14 is a second flowchart illustrating one example of the control operation in the image forming apparatus system in the first embodiment of the present disclosure.

First, a description will be given of one example of the operation of the image forming apparatus system 400 when the user does not have a QR code. As illustrated in FIG. 13, the user operates the image forming apparatus 100 to use the content service (step S101). Specifically, when the user operates the operation unit 115, the processor 185 instructs the content transmitting/receiving unit 166 so as to transmit a content transmission instruction to the content server 200. When the content transmitting/receiving unit 166 receives data regarding content from the content server 200, the processor 185 instructs the image forming unit 113 so as to print the content. The data regarding the content from the content server 200 is stored in the storage unit 184.

The image forming unit 113 prints the content on paper, and the paper is ejected from the sheet ejection tray 114a to thereby execute a job (step S102).

When the user operates the operation unit 115 to finish the content service (step S103), the QR code regarding the use history information is displayed on the display unit 161 (step S104), and this control operation ends. Specifically, when the user operates the operation unit 115 to finish the content service, the processor 185 causes the code generator 181 to generate a QR code, based on data stored in the storage unit 184. The operation unit 115 then causes the display unit 161 to display the generated QR code. In this example, since the user has not performed setting on the image forming apparatus 100 by using the QR code or has not selected content, there is no previous use history information, and thus the use history information is updated in a manner that new use information is added to the use information obtained this time.

The user photographs the QR code displayed on the display unit 161 by using his or her smartphone (step S105) and uses the QR code next time he or she uses the image forming apparatus 100.

Next, a description will be given of one example of the operation of the image forming apparatus system 400 when the user has a QR code regarding the use history information. As illustrated in FIG. 14, first, the user operates the image forming apparatus 100 to select a content service (step S201). Specifically, the user operates the operation unit 115 to select a content service.

The image forming apparatus 100 enters a state in which it is ready to read the QR code (step S202). For example, the processor 185 causes the display unit 161 to perform display for urging reading of the QR code.

For example, the user causes the QR code, obtained after the last use of the image forming apparatus 100 and stored in the smartphone, to be displayed on the smartphone (step S203) and places the QR code over the QR code reader 162 for reading.

When the QR code reader 162 reads the QR code (step 3204), the processor 185 causes the code analyzer 182 to analyze the QR code. The code analyzer 182 generates the use history information included in the QR code, and the use history information is stored in the storage unit 184. In addition, the setter 183 sets the use history information, and, for example, content used in the past is displayed on the display unit 161. The user selects, from the displayed content, content he or she desires to obtain.

Based on the content code of the selected content, the processor 185 causes the content transmitting/receiving unit 166 to transmit a content transmission instruction (step S205).

When the transmitting/receiving unit 203 in the content server 200 receives the content transmission instruction, the controller 201 determines whether or not the present time is within a content provision period, based on the content code (step S206).

When the present time is within the provision period (Yes in step S206), the controller 201 obtains corresponding content data from the content storage unit 202 and causes the content data to be transmitted from the transmitting/receiving unit 203 to the image forming apparatus 100 (step S208).

Also, when the present time is not within the provision period (No in step S206), the controller 201 determines whether or not similar content, which is content associated with the corresponding content, is stored in the content storage unit 202 (step S207).

When no similar content is stored (No in step S207), the controller 201 causes the transmitting/receiving unit 203 to transmit a signal indicating that no content is stored. When the content transmitting/receiving unit 166 receives the signal, the processor 185 causes the display unit 161 to display information indicating that no content is stored (step S210), thereby ending the control operation.

When similar content is stored (Yes in step S207), the controller 201 obtains content data of the similar content from the content storage unit 202 and causes the content data to be transmitted from the transmitting/receiving unit 203 to the image forming apparatus 100 (step S208).

Based on the content data transmitted from the content server 200 to the content transmitting/receiving unit 166, the processor 185 causes the display unit 161 to perform display regarding the corresponding content or the similar content (step S209).

After the display unit 161 performs display regarding the content, a determination is made as to whether or not download of the content data is to be performed (step 3211). Specifically, a determination is made as to whether or not the user gives an instruction for printing the content.

When the content is not to be downloaded, that is, when the user does not give an instruction for printing the content (No in step S211), the control operation ends.

When the content is to be downloaded, that is, when the user gives an instruction for printing the content (Yes in step S211), print data is downloaded (step S212). Specifically, the content transmitting/receiving unit 166 receives the print data of the content from the content server 200, and the content data and the print data are stored in the storage unit 184. The content data is data indicating details of the content, and the print data is data that is used for printing the content.

Then, a print job is executed (step S213). Specifically, the processor 185 instructs the image forming unit 113 so as to print the content on paper, based on the print data stored in the storage unit 184, and the image forming unit 113 prints the content, and the paper is ejected from the sheet ejection tray 114a.

When the user operates the operation unit 115 to finish the content service (step S214), the QR code read by the QR code reader 162 is updated (step S215), and the updated QR code is displayed on the display unit 161 (step S216), thereby ending the control operation. Specifically, when the operation unit 115 performs an operation for finishing the content service, the information updater 187 adds the use information obtained this time to the use history information, stored in the storage unit 184, to update the use history information in accordance with an instruction from the processor 185. In this case, part of the use history information is deleted, as appropriate. In addition, in accordance with an instruction from the processor 185, the code generator 181 generates a QR code, based on the updated use history information. The generated QR code is then displayed on the display unit 161.

The user photographs the QR code displayed on the display unit 161 by using his or her smartphone (step S217) and uses the QR code next time he or she uses the image forming apparatus 100.

### Second Embodiment

An image forming apparatus system according to a second embodiment of the present disclosure has a smartphone, and the image forming apparatus transmits a QR code to the smartphone, which is a point different from the image forming apparatus system 400 according to the first embodiment of the present disclosure, and other points are the same as or similar to those in the image forming apparatus system 400. The points that are the same as or similar to those in the first embodiment will not be described hereinafter. In the drawings, the same or similar members are denoted by the same reference numerals.

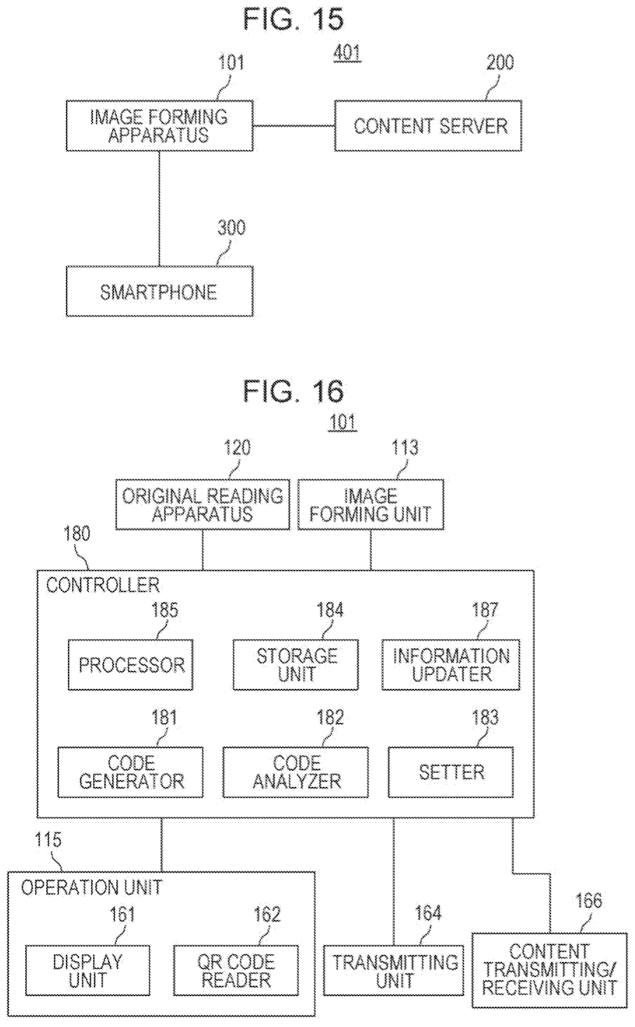

FIG. 15 is a schematic diagram illustrating the configuration of an image forming apparatus system according to the second embodiment of the present disclosure.

As illustrated in FIG. 15, an image forming apparatus system 401 includes an image forming apparatus 101, the content server 200, and a smartphone 300. The image forming apparatus 101 is placed, for example, at a convenience store. The image forming apparatus 101 has a configuration (described below) in which a transmitting unit that is capable of communicating with the smartphone 300 is added to the image forming apparatus 100 in the first embodiment. Other configurations of the image forming apparatus 101 are the same as or similar to those of the image forming apparatus 100.

As described above, the image forming apparatus 101 is capable of transmitting data to the smartphone 300. Thus, a QR code generated by the image forming apparatus 101 can be transmitted to the smartphone 300.

FIG. 16 is a block diagram schematically illustrating control configuration in an image forming apparatus included in the image forming apparatus system according to the second embodiment of the present disclosure.

As illustrated in FIG. 16, the image forming apparatus 101 includes a transmitting unit 164 in addition to the configuration of the image forming apparatus 100. The transmitting unit 164 transmits data to external equipment through a network. Specifically, the transmitting unit 164 can communicate with the smartphone 300. The transmitting unit 164 may be able to transmit data to the smartphone 300 by using infrared. For example, the transmitting unit 164 may be able to transmit data through a wireless local area network (LAN), such as a Wi-Fi network. The transmitting unit 164 may also be able to transmit data to the smartphone 300 through other means.

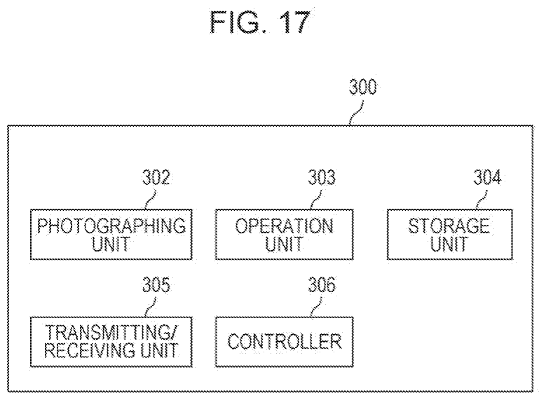

The configuration of the smartphone 300 will now be described with reference to FIG. 17.

FIG. 17 is a block diagram schematically illustrating a control configuration of the smartphone included in the image forming apparatus system according to the second embodiment of the present disclosure.

As illustrated in FIG. 17, the smartphone 300 includes a photographing unit 302, an operation unit 303, a storage unit 304, a transmitting/receiving unit 305, and a controller 306.

The photographing unit 302 has a camera to photograph a subject.

The operation unit 303 includes operation buttons or the like for the user to operate the smartphone 300. The smartphone 300 has a display screen, which is a touch panel display, and when the user touches the display screen, he or she can perform operation input. Thus, the operation unit 303 also includes the display screen.

The storage unit 304 stores a QR code transmitted from the image forming apparatus 101. The storage unit 304 also stores application software and so on downloaded from a predetermined address.

The transmitting/receiving unit 305 communicates with external equipment through a network. For example, the transmitting/receiving unit 305 may also be able to communicate with the image forming apparatus 101. The transmitting/receiving unit 305 may also be able to communicate with the image forming apparatus 101 by using infrared. For example, the transmitting/receiving unit 305 may also be able to transmit data through a LAN, such as a Wi-Fi network. The transmitting/receiving unit 305 may also be able to transmit data to the smartphone 300 through other means.

The controller 306 centrally controls overall operation of the smartphone 300 and makes various determinations.

Operations of the image forming apparatus system 401 are substantially the same as those of the image forming apparatus system 400 according to the first embodiment. However, rather than the user photographing a QR code displayed on the display unit 161 by using the smartphone 300, the user operates the operation unit 115 and the operation unit 303 to thereby cause the transmitting unit 164 to transmit the QR code to the smartphone 300. Specifically, the QR code may be transmitted instead of step S104 in FIG. 13 and S216 in FIG. 14, and the QR code may be received instead of step S105 and step S217.

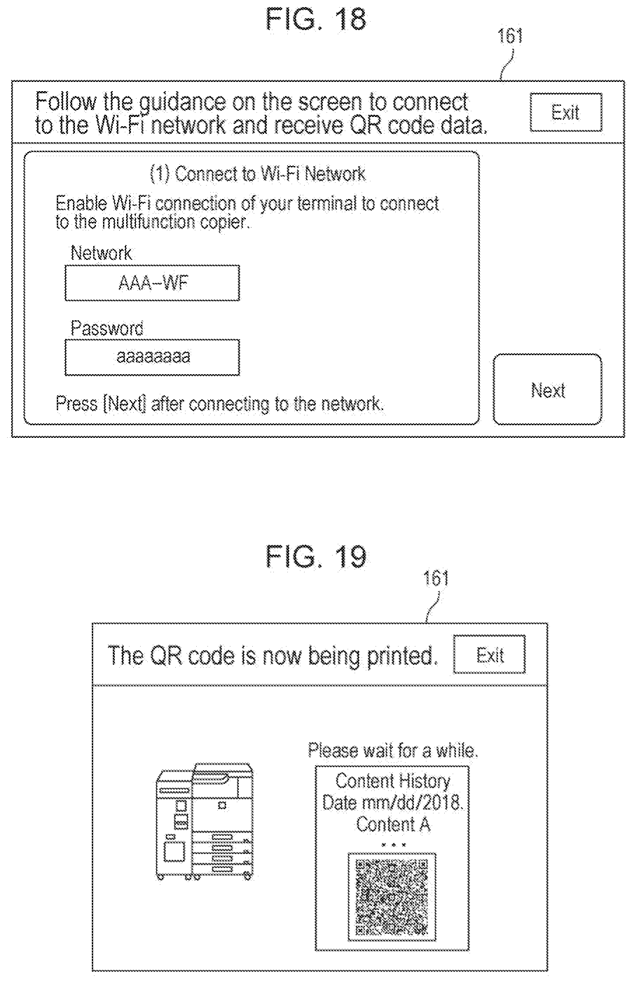

FIG. 18 is an image view illustrating one example of an image displayed on the display unit in the image forming apparatus according to the second embodiment of the present disclosure. In the second embodiment, after the content service is finished, a screen for prompting the user to receive the QR code may be displayed on the display unit 161, as illustrated in FIG. 18.

The user stores the QR code, received by the smartphone 300, in the storage unit 304. Next time the user uses the image forming apparatus 101, the user causes the stored QR code to be displayed on the display screen and places the QR code over the QR code reader 162 of the image forming apparatus 101 for reading.

The image forming apparatus 101 may also have a receiving unit for receiving data transmitted from the smartphone 300, other than the transmitting unit 164. This makes it possible to omit QR code reading performed by the QR code reader 162. Thus, since the work for making the QR code reader 162 read the QR code can be omitted, the amount of load on the user is reduced. In addition, in this case, the QR code reader 162 may be omitted, thus making it possible to reduce cost.

As described above, according to the image forming apparatus system 401, the QR code is transmitted from the image forming apparatus 101 to the smartphone 300, thus allowing the user to easily obtain the QR code.

### OTHER EMBODIMENTS

Although a case in which the image forming apparatus displays the QR code has been described in the image forming apparatus system 400 according to the first embodiment of the present disclosure, the QR code may be printed on paper. For example, in the image forming apparatus system 400, after the code generator 181 generates the QR code, the image forming unit 113 may print the generated QR code on paper and may eject the paper to the sheet ejection tray 114a.

FIG. 19 is an image view illustrating one example of an image displayed on the display unit of the image forming apparatus according to another embodiment of the present disclosure.

During printing of the QR code, the display unit 161 may perform display for giving a notification indicating that the QR code is now being printed, as illustrated in FIG. 19.

According to this image forming apparatus system, even the user who does not possess a portable terminal, such as a smartphone, can operate the image forming apparatus 100 by using the QR code, thus reducing the amount of load on the user who does not possess a portable terminal.

Although the image forming apparatuses 100 and 101 according to the embodiments of the present disclosure have been described above, image forming apparatuses according to the present disclosure are not limited to the above description. For example, in the image forming apparatus 100 or 101, although the information updater 187 adds use information obtained this time to use history information obtained last time the image forming apparatus 100 or 101 was used and earlier than the last time, to update the use history information, the updated use history information may be continuously stored in the storage unit 184. That is, each time the user uses the image forming apparatus 100 or 101, the storage unit 184 adds use information thereof to use history information, which is information regarding history of use information of the user, to thereby accumulate and store the use information. Thus, even when a QR code is not used, the use history information can be retrieved from the storage unit 184 in the image forming apparatus 100 or 101.

This allows the setter 183 to perform setting by using the use history information stored in the storage unit 184. For example, pieces of content used in the past are displayed on the display unit 161. The user selects desired content he or she desires to obtain among the pieces of displayed content.

As described above, without the QR code reader 162 reading a QR code, the image forming apparatus 100 or 101 can execute the same processes as processing details that were previously used, thus making it possible to reduce users' operation work.

With respect to display of content, all use history information that was used in the past may be displayed, and, for example, most-recent use history information for three cases or the like may be displayed.

The present disclosure is not limited to the embodiments described above and may be implemented in various other forms. Thus, it is to be understood that the embodiments disclosed herein are merely examples in all respects and are not construed as limiting. The scope of the present disclosure is to be interpreted by the appended claims and is not constrained by the specification. In addition, it is to be understood that changes and modifications that belong to an equivalent scope of the claims are all encompassed by the scope of the present disclosure.

The present disclosure contains subject matter related to that disclosed in Japanese Priority Patent Application JP 2018-156289 filed in the Japan Patent Office on Aug. 23, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image forming apparatus comprising:
an image-code reading unit that reads an image code;
a use-history-information generating unit that analyzes the image code read by the image-code reading unit and that generates use history information that is information regarding a history of use information of a user;
a use-history updating unit that adds use information obtained this time to the use history information generated by the use-history-information generating unit, to update the use history information;
an image-code generating unit that generates the image code, based on the use history information updated by the use-history updating unit; and
an image-code outputting unit that outputs the image code generated by the image-code generating unit.

2. The image forming apparatus according to claim 1, further comprising:
a use-information setting unit that performs setting based on the use information selected by an operation of the user from the use history information generated by the use-history-information generating unit.

3. The image forming apparatus according to claim 2, further comprising:
a use-history-information storing unit in which each time the user uses the image forming apparatus, use information thereof is added to the use history information, accumulated, and stored,
wherein the use-information setting unit performs setting based on the use information selected by an operation of the user from the use history information generated by the use-history-information generating unit and the use history information stored in the use-history-information storing unit.

4. The image forming apparatus according to claim 1,
wherein the image-code outputting unit comprises a display unit that displays the image code generated by the image-code generating unit.

5. The image forming apparatus according to claim 1,
wherein the image-code outputting unit comprises a transmitting unit that transmits the image code generated by the image-code generating unit to a portable terminal that is an external device.

6. The image forming apparatus according to claim 1,
wherein the image-code outputting unit comprises a printing unit that prints the image code, generated by the image-code generating unit, on paper.

7. The image forming apparatus according to claim 1,
wherein, when the use history information before the update includes use information of a predetermined number of cases or more, the use-history updating unit deletes oldest use information of the use history information and adds the use information obtained this time so that a number of pieces of use information, the number being larger than the predetermined number of cases, are not included in the use history information.

8. The image forming apparatus according to claim 1,
wherein, when the use history information before the update includes use information obtained a predetermined number or more days before, the use-history updating unit deletes the use information obtained the predetermined number or more days before and then adds the use information obtained this time.

9. The image forming apparatus according to claim 1,
wherein the use history information includes operation setting information that is information regarding operation details set by the user;
the use-history-information generating unit generates the operation setting information included in the image code; and
the image forming apparatus further comprises a setting unit that performs setting according to the operation details based on the operation setting information generated by the use-history-information generating unit.

10. The image forming apparatus according to claim 1,
wherein the image code is a QR cod.

11. An image forming apparatus system comprising:
the image forming apparatus according to claim 1; and
a server that is transmittable/receivable data to/from the image forming apparatus,
wherein the server stores content information therein, and transmits the content information to the image forming apparatus, based on a transmission instruction from the image forming apparatus.

12. The image forming apparatus system according to claim 11,
wherein, when the server does not store therein content information for which the transmission instruction from the image forming apparatus is issued, the server transmits similar content information that is highly associated with the content information to the image forming apparatus.
